(19) United States
(12) Patent Application Publication
(10) Pub. No.: US 2006/0233319 A1
(43) Pub. Date: Oct. 19, 2006

(54) Automatic messaging system

(76) Inventors: Patience N. Van Zandt, Santa Clara, CA (US); Thomas A. Van Zandt, Santa Clara, CA (US)

Correspondence Address: Thomas Van Zandt, 5255 Stevens Creek Blvd. #299, Santa Clara, CA, 95051, US

(21) Appl. No.: 11/397,714

(22) Filed: Apr. 5, 2006

Related U.S. Application Data
(63) Continuation-in-part of application No. 10/629,393, filed on Jul. 29, 2003.
(60) Provisional application No. 60/399,510, filed on Jul. 30, 2002.

(51) Int. Cl. H04M 1/64

(52) U.S. Cl. 379/67.1

(57) ABSTRACT

A method and system for an automatic messaging service. For one embodiment a messaging service associates a network address information specifying a network address with a user. When a message from a caller is subsequently received at the messaging service, the message is converted to message file which may be an audio file, a video file, a text file, or a multi-media file. The message file is then forwarded to the network address associated with the user.

### CROSS-REFERENCE TO RELATED APPLICATION

This application is a continuation-in-part application of U.S. patent application Ser. No. 10/629,393 entitled “Automatic Messaging System,” filed on Jul. 29, 2003, which claims priority to provisional application Ser. No. 60/399,510, filed on Jul. 30, 2002, entitled “Automatic Messaging System,” the teachings of which are incorporated by reference herein.

### FIELD

Embodiments of the invention relate generally to the field of digital communication systems and more specifically to an automatic messaging system.

### BACKGROUND

Typical telephone messaging devices allow a user to receive multiple voice messages from any number of different callers who call at a time when the user is unavailable to take the call personally. In the simplest scenario, a caller will place a call to the user's phone number and if the user does not accept the call, the caller is presented with a message (i.e., an outgoing message (OGM)) prompting the caller to leave a message. The OGM may suggest the content of the message the caller leaves. For example, the OGM may ask request that the caller provide name and phone number or even the time the call was made. The OGM may further request specific details of the nature of the call.

Typically the caller may disregard such requests and leave a message with whatever content the caller desires. Over the past several decades, the messaging services have been able to provide the user with more information regardless of the caller's message. For example, typical messaging services will provide the user with the time the call was received, and can also provide the caller's phone number (the number from which the call was received) and a name of the caller associated with the number provided.

From the earliest days of telephone messaging systems, the storage of messages has been problematic. In the early days of telephone answering machines, the answering machine used a tape recording device to record messages from callers. The tape was limited in storage capacity and thus limited the number of messages that could be received. If the tape became completely filled, additional messages could not be recorded. In some cases, the tape would rewind to accommodate additional messages, but would record over previous messages. In some circumstances this was acceptable to the user as the previous messages at the beginning of the tape had already been reviewed. In some cases, a caller was allowed to record a message of up to the capacity of the remaining tape. Thus one long message would preclude additional messages from being recorded. This was addressed with the limited duration message that allowed a caller only a relatively short period (e.g., 30 seconds) to record a message. This addressed the problem to an extent, but often resulted in a caller making repeated calls in order to complete the caller's desired message.

As answering machines switched to digital storage capabilities some of the problems were resolved. For example, messages were no longer recorded over. However, storage capacity, in whatever form, has an associated cost, and the digital storage answering machines were still limited in the number of messages that could be stored. Once the storage capacity was reached, the user would typically have to delete some stored messages before new messages could be stored.

Within the past ten years, most users have moved from telephone answering machines to messaging services provided via a telecommunications system. Such services allow the user to record an out-going message at a central site, the out-going message is then presented to a caller if the user does not answer their phone for a specified number of rings (e.g., 4 rings). Such systems do not store messages on the individual user's device. Rather messages are stored for each user's account on centralized processing systems. Therefore, such messaging services are capable of storing a vast number of messages for each user. However vast their storage capacity, the number of users is also vast. Therefore such systems typically limit a user to a specified number of messages that will be stored (e.g. 25 messages). When the limit is reached, such systems typically preclude a subsequent caller from leaving a message. The system may respond to the caller with a statement to the effect that the “voice mailbox” is full. Such systems may also notify the user that their mailbox is full and request the user to delete some or all of the stored messages in order to receive new messages.

Such schemes are disadvantageous in that a user may not be aware that their mailbox is full or may not be able to listen to their messages and delete them for some period. For example, cell phones typically have a limited range of operability. If a cell phone user is outside that range, the user cannot check their messages and cannot delete some of the messages. The messages continue to accumulate until they reach capacity at which point new messages are precluded.

Additionally, typical messaging systems will typically store any given message for only a specified period of time even when the message storage capacity of the user's account is not reached. When a user listens to a message, the system will provide the user with the option of deleting the message or of saving the message. If the user opts to save the message, the system will indicate how long it will be saved (“message will be saved for 7 days”).

Such schemes are disadvantageous in that a user may desire to store messages for an indefinite period of time that is longer than the typical period offered by a messaging system. Some such systems will allow a user to repeatedly resave the message, but this is time consuming and prone to error (e.g., a user may forget to resave an important message).

The messaging systems could provide for increased storage capacity and long-term storage of messages, but the required large-scale storage for thousands of users is cost prohibitive, not marketable, and may expose the messaging service provider to liability for lost messages.

Another disadvantage of typical messaging systems is that the messages are stored in the order received and the users are not provided with the ability to organize stored messages for easy access. Therefore when a user calls the messaging system they cannot distinguish between messages they would like to listen to immediately and messages they would like to listen to later, or to discard. This problem is partially addressed by “caller identification”. For example, when a user plays the message, the prelude to the message tells the user the number from which the message was received. This gives the user the option of listening to the message, deleting the message, or skipping (postponing listening to) the message.

Such a scheme is disadvantageous in that the user must make this decision based only on the number from which the message was received, and this may not be enough information for the user to make that decision. Moreover, the user must, typically, proceed through each of their messages before these options are available.

### SUMMARY

An embodiment of the present invention provides a method and system for an automatic messaging service. A messaging service associates a network address information specifying a network address with a user. When a message from a caller is subsequently received at the messaging service, the message is converted to message file which may be an audio file, a video file, a text file, or a multi-media file. The message file is then forwarded to the network address associated with the user.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 is a process flow diagram in accordance with one embodiment of the present invention;

FIG. 2 is a functional block diagram of a system in accordance with one embodiment of the present invention;

FIG. 3 is a block diagram illustrating one embodiment of a processing system 300 that may be used for the central site 205 in accordance with an embodiment of the present invention;

FIG. 4 is a process flow diagram in which a message is received and forwarded to network address in accordance with one embodiment of the present invention;

FIG. 5 is a functional block diagram of a telephone messaging system in accordance with one embodiment of the invention; and

FIG. 6 illustrates a user's display screen displaying telephone messages received from a telephone messaging system in accordance with one embodiment of the invention.

### DETAILED DESCRIPTION

A method and system for an automatic messaging service is disclosed. For one embodiment, a messaging service associates a network address information specifying a network address with a user. When a message from a caller is subsequently received at the messaging service, the message is converted to message file which may be an audio file, a video file, a text file, or a multi-media file. The message file is then forwarded to the network address associated with the user.

For one embodiment of the invention, a recorded message is converted to an audio file (e.g., MP3 file, WAV file, etc.) and sent via a network to an account associated with the user (e.g., a user's e-mail account). For one such embodiment, the conversion of the recorded message and forwarded of the resultant message file is done automatically upon receipt of the message from the caller. In an alternative embodiment, when the user calls the messaging service to listen to the recorded messages, the user is presented with the option of having each message converted and forwarded or not. For example, the user may desire to have particular messages converted and forwarded, while desiring to have other messages deleted.

For one embodiment of the invention, the message files are stored on a server (e.g., maintained by the messaging service provider) to which the user has access.

For one embodiment of the invention, only messages from pre-specified numbers are converted to message files and forwarded to the received network address. For example, the user may desire only messages received from a particular number, which may be identified using a conventional caller ID mechanism, to be converted and forwarded.

For one embodiment of the invention, the recorded messages from the caller are transcribed and converted to text files prior to forwarding to the received network address. For one such embodiment, the recorded messages are automatically transcribed using conventional voice recognition mechanisms.

For one embodiment of the invention, the message files are designated with filenames that provide information to the user regarding the message. For one such embodiment, the message files have filenames that include the calling number from which the message was received. For one embodiment, a name or name-portion associated with the calling number may be used to form the title of the message file. For one embodiment of the invention, the message files are dated and time stamped based upon when the message was received from the caller by the messaging service. For one embodiment of the invention in which messages are transcribed, the message file may assign a filename based upon key word recognition.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

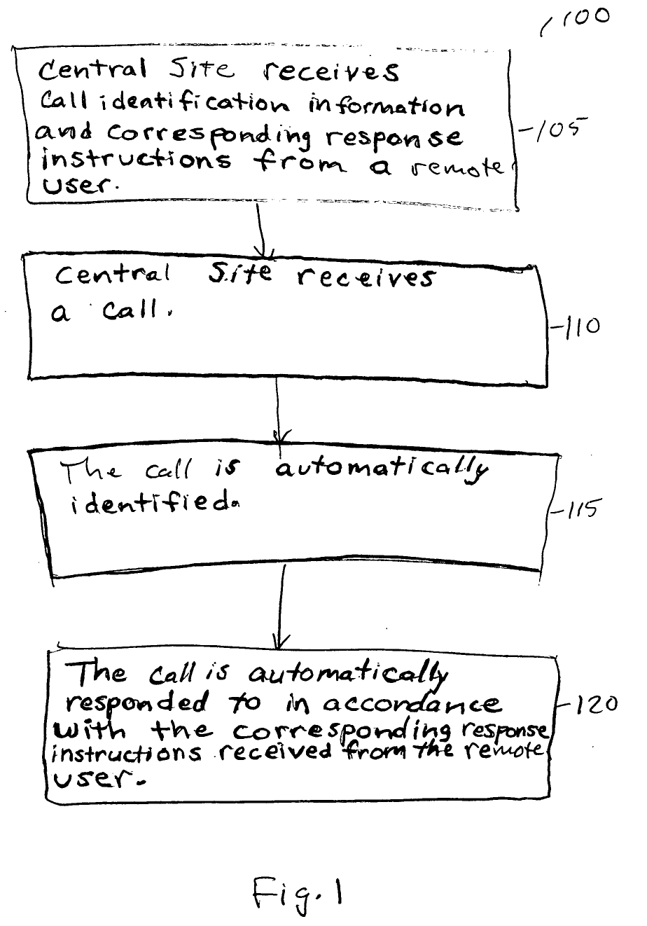

FIG. 1 is a process flow diagram in accordance with one embodiment of the present invention. Process 100, shown in FIG. 1, begins with operation 105 in which a central site receives call identification information and corresponding response instructions from a remote user. For example, a remote user may call the central site and provide call identification information in the form of an originating telephone number of the call. Alternatively, the call identification information may be a name of a prospective caller or may be a pre-arranged tonal or numeric code, or some other form of identification. The remote user also provides response instructions for the call identification information, which may be a specific recorded text, voice, and/or video message. For one embodiment, the corresponding response instructions may be to automatically forward the call to an alternative telephone number of the remote user.

At operation 110 a call is received at the central site. For one embodiment, the received call is originally placed to the telephone number of the remote user and upon a “busy signal”, or no answer at the remote user's telephone, the call is automatically forwarded to the central site.

At operation 115, the call is automatically identified. For an embodiment in which the call identification information provided by the remote user is an originating phone number of the call, the call is automatically identified through a “caller ID” mechanism. Such “caller ID” functionality is well known in the art for the purpose of call screening and/or call avoidance. For an alternative embodiment where the call identification information is a caller name, the call may be automatically identified by prompting the caller to say their name and identifying the call via a speech recognition mechanism. In a preferred embodiment, such a speech recognition system is based on overall speech patterns so that the call may be identified by comparing the remote user's input with the caller's input.

At operation 120 the call is responded to automatically in accordance with the corresponding response instructions received from the remote user. For example, the remote user may have recorded a specific message for a particular caller. In an alternative embodiment, the remote user may have instructed that a call from a particular caller be forwarded to a specified alternative telephone number of the remote user.

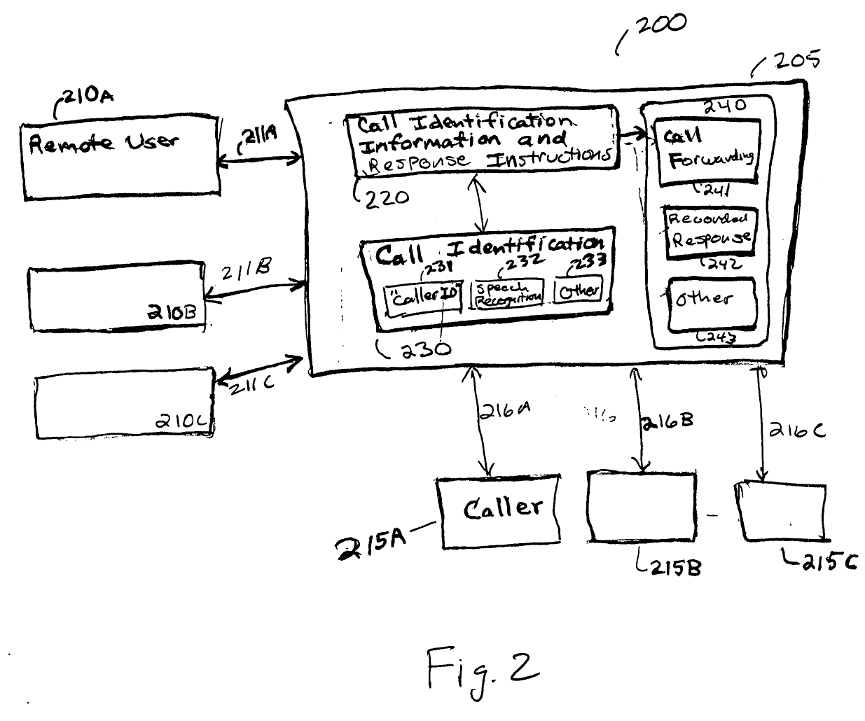

FIG. 2 is a functional block diagram of a system in accordance with one embodiment of the present invention. System 200 includes a central site 205 coupled to a number of remote users 210A-210C and a number of callers 215A-215C via communication links 211A-211C and 216A-216C, respectively. Links 211A-211C and 216A-216C may be wired or radio telephone links or network links, for example, which may communicate any combination of a number of different types of data including for example video, audio, graphics, text, multi-media or the like. For example the data may be audio/video data, such as programs with moving images and sound. However, it will be appreciated that the data files communicated in accordance with the teachings of various embodiments of the present invention are not limited only to audio/video data.

Central site 205 includes user input module 220 for receiving and storing call identification information and corresponding response instructions. Coupled to the user input module 220 is call identification module 230. Call identification module 230 uses the call identification information from user input module 220 to identify a call. Depending on the form of the call identification information, call identification module 230 may contain a number of distinct units such as caller ID unit 231, speech recognition unit 232, or other call identification functionality shown for example as unit 233.

Also coupled to user input module 220 is call response module 240. Call response module 240 uses the response instructions from user input module 220 to respond to a call. Depending on the response instructions, call response module 240 may contain a number of distinct units such as call forwarding unit 241, recorded response unit 242, or other call response functionality shown for example as unit 243.

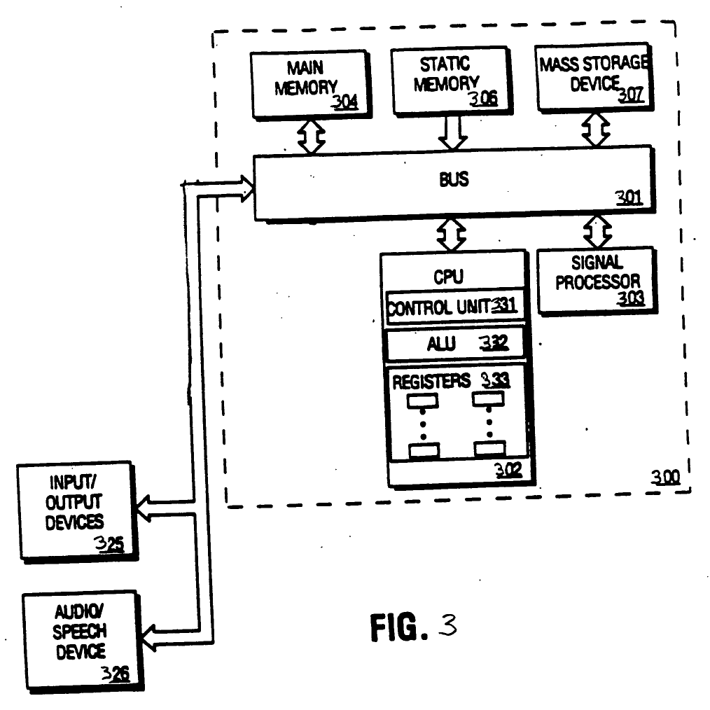

FIG. 3 is a block diagram illustrating one embodiment of a processing system 300 that may be used for the central site 205 in accordance with an embodiment of the present invention. For alternative embodiments of the present invention, processing system 300 may be a mainframe, personal, or portable computer. For one embodiment, each module of central site 205 contains a processing system.

The components of processing system 300 are exemplary in which one or more components may be omitted or added. For example, one or more memory devices may be utilized for processing system 300.

Referring to FIG. 3, processing system 300 includes a central processing unit 302 and a signal processor 303 coupled to a main memory 304, static memory 306, and mass storage device 307 via bus 301. Processing system 300 may also be coupled to input/output (I/O) devices 325, and audio/speech device 326 via bus 301. Bus 301 is a standard system bus for communicating information and signals. CPU 302 and signal processor 303 are processing units for processing system 300. CPU 302 or signal processor 303 or both may be used to process information and/or signals for processing system 300. CPU 302 includes a control unit 331, an arithmetic logic unit (ALU) 332, and several registers 333, which are used to process information and signals. Signal processor 303 may also include similar components as CPU 302.

Main memory 304 may be, e.g., a random access memory (RAM) or some other dynamic storage device, for storing information or instructions (program code), which are used by CPU 302 or signal processor 303. Main memory 304 may store temporary variables or other intermediate information during execution of instructions by CPU 302 or signal processor 303. Static memory 306, may be, e.g., a read only memory (ROM) and/or other static storage devices, for storing information or instructions, which may also be used by CPU 302 or signal processor 303. Mass storage device 307 may be, e.g., a hard or floppy disk drive or optical disk drive, for storing information or instructions for processing system 300.

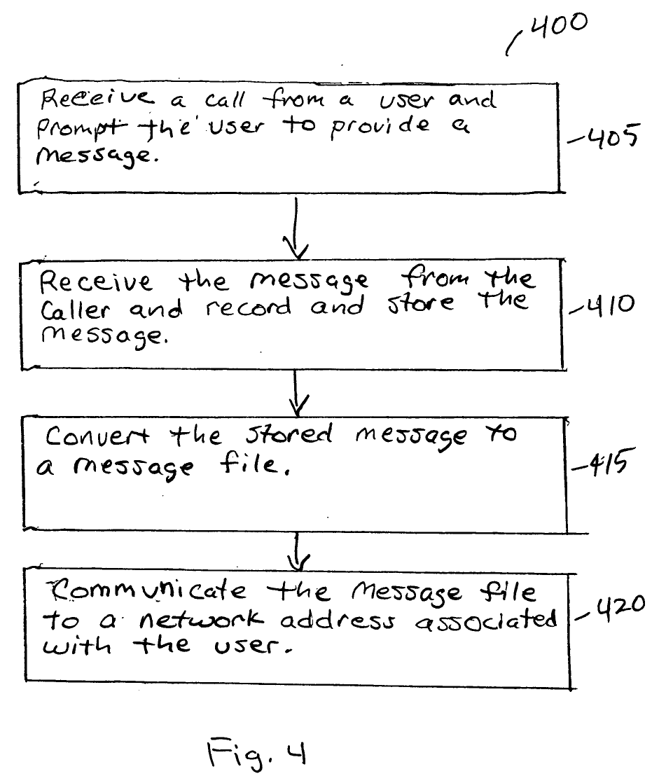

FIG. 4 is a process flow diagram in which a message is received and forwarded to a network address in accordance with one embodiment of the present invention. Process 400, shown in FIG. 4, begins with operation 405 in which a messaging system receives a call from a caller that has been unanswered by the user, presents an OGM of the user, and prompts the caller to provide a message for the user. For one embodiment of the invention, the call may be received at a central site as described above. For one embodiment of the invention, the OGM is a standardized message presented in response to calls directed to one or more users.

At operation 410, the message from the caller is received by the messaging service, recorded and stored. The message from the caller may be in a variety of formats including spoken language and video or audio clips, or other types of analog or digital information.

At operation 415, the stored message is converted to a message file which may be any suitable type of file depending upon the received message. For example, where the received message is spoken language, the recorded message may be converted to an audio file suitable for transmission via any number of types of communications network through which a plurality of different devices may communicate. For example, the recorded message may be converted to an audio file suitable for transmission via the Internet, which is a network of networks having a method of communicating that is well known to those skilled in the art.

For various embodiments, the recorded message may be converted to an audio file such as an Moving Pictures Expert Group, audio layer 3 (MP3) file or a WAV file or a Broadcast Wave Format (BWF) file. The recorded message may also be converted to a video file such as a Moving Pictures Expert Group (MPEG) standard file (e.g., MPEG-4).

At operation 420 the message file is communicated to a network address associated with the user. As will be apparent to those skilled in the art, the network address as well as the association of the network address with the user may be in various forms.

For one embodiment of the invention, the network address is an internet protocol (IP) address. An IP address is a unique number that devices use to identify and communicate with one another using the IP standard. Such devices may include routers, computers, and telephones, for example, or other types of DPSs as described above.

For one embodiment of the invention, the network address is an e-mail address associated with the user. For such an embodiment the message file may be sent as an attachment to the e-mail address. In an alternative embodiment, the network address may correspond to a server DPS having storage capacity to which the user has access.

As noted above, the messaging service may label each message file in a manner that is helpful to the user in deciding how to respond to the message. For example, the messaging service may designate a filename for each message file that conveys information about the message to the user.

For one embodiment of the invention, message file is designated based upon caller identification information of the number from which the message originated. This may be, for example, creating a filename for the message file that includes some or all of the originating number (e.g., 408.849.3274.file.ext). For another embodiment, if the caller identification information includes a name associated with the calling number, some or all of the associated name may be used in creating the filename (e.g., John.Smith.file.ext). For one embodiment, such information may be available by accessing a number/name correspondence table of the user's system.

Where caller identification information is not available, the message file may be designated with a filename indicating with such information as is typically available to messaging services such as the date and time the message was received and/or the duration of the message (e.g., 4_{—}4_{—}06_{—}13:45_{—}1:30_message).

For one embodiment of the invention, the messaging service receives and records an audio message (e.g., a spoken or pre-recorded message) from a caller, transcribes the audio message, and converts the message to a text file. For one embodiment, the message may be transcribed automatically using conventional voice recognition mechanisms. As described above, the text file may then be forwarded to, for example, an e-mail account of the user. For such an embodiment, the message file may be designated based upon the contents of the message. For example, a filename for the message file may be created based upon keywords of the message. Such keywords may include terms such as proper nouns for example, personal names or may include rarely used words and jargon. Such terms may be recognized in a number of ways including context. For example, telephone messages often include the phrase “this is” followed by the name of the caller. Where the phrase this is followed by a proper noun, the proper noun may be used to form the filename of the message file. Another common content of telephone messages is a phone number where the caller can be reached. Therefore, if the message contains digits that are recognizable as a phone number, the phone number can be used in place of, or in addition to, the phone number provided through conventional caller identification mechanisms. There are many other examples of discerning keywords as known in the art of context recognition. For example, telephone messages often contain the phrase “I'm calling about (or “in regard to”)” followed by the subject of the message. Where such phrases are present, the term that follows may be used to designate the message file (e.g., form the basis of a filename for the message file.

The process described above in reference to FIG. 4 provides many advantages to the user in reviewing, organizing, and storing telephone messages. The user may be able to access the messages while in a situation where accessing the messages from a conventional messaging system would not be possible. For example, if the user's cell phone messages are forwarded to the user's e-mail account, the user may be able to access those messages at a time or geographical location at which access to e-mail is available, but access to cell phone service is not. If the phone messages are transcribed, the user may be able to access the messages by reading them in a situation in which listening to the messages is not desirable.

If the user can view a set of telephone messages as well as view time received and subject information, the user can quickly bypass or delete recognizably unimportant messages (e.g., subjectively unimportant to the user) and quickly access more important messages. This could save the user a great deal of time in reviewing and addressing multiple phone messages. For example, for one embodiment, the message files are provided as list of files on the user's telephone display screen. Each message file has a filename indicating information about the message. By reading the filenames the user may be able to quickly decide which messages should be deleted, saved, accessed immediately, or presently bypassed (i.e., skipped).

Further, the user has the information in a system and in a context in which the user can easily store the information (on a relatively permanent basis) more easily.

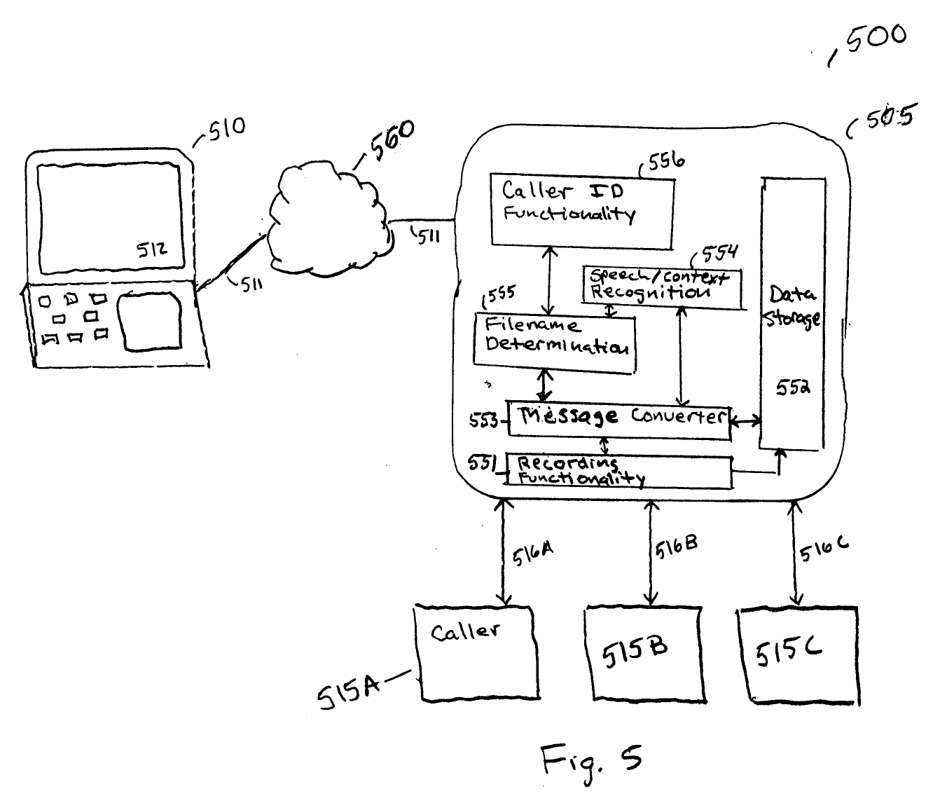

FIG. 5 is a functional block diagram of a telephone messaging system in accordance with one embodiment of the invention. System 500 includes a message conversion system 505, which may be located in a centralized site servicing multiple users or may in an alternative embodiment be contained in the telephone system of a particular user. The system can accommodate any number of callers, shown for example as callers 515A-515C. The callers can communicate with the message conversion system 505 via communication links 516A-516C, which may communicate any combination of a number of different types of data including for example video, audio, graphics, text, multi-media or the like. For example the data may be audio/video data, such as programs with moving images and sound. However, it will be appreciated that the data files communicated in accordance with the teachings of various embodiments of the present invention are not limited only to audio/video data.

Messages received from the caller (e.g., caller 515A) may be recorded by the recording functionality 551 and stored in the data storage 552. The message converter 553 converts the stored message to a message file. For alternative embodiments of the invention, the message may not be stored, but may be converted to a message file upon being received or recorded. For some embodiments of the invention, the message from the caller is received in a suitable format and is not converted.

For one embodiment of the invention the message converter uses speech/context recognition 554 to convert the message to a text file.

For some embodiments, a filename for each message file is determined using filename determination functionality 555. The filename may be determined after the message is converted to a message file or prior to conversion. The filename determination functionality may use speech/context recognition 554, caller identification functionality 556, or both to determine a filename for the message files.

After the received message has been converted, if necessary, and a filename designated for the resultant message file, the message file is communicated to a network address associated with the user. For example, the message conversion system 505 may communicate the message file through communication links 511, via the Internet 560, to a storage location having a network address associated with the user. The user may access the message file using a processing system 510. The processing system which may be a computer, a PDA, a telephone (including wired or wireless telephones), or other type of digital processing system, has a display 512 through which the user may view the message files as filenames prior to accessing the content of the message files using the processing system 510.

Using the processing system 510, the user may readily review, organize, delete, or save the message files, as well as access the contents of the message files as described above.

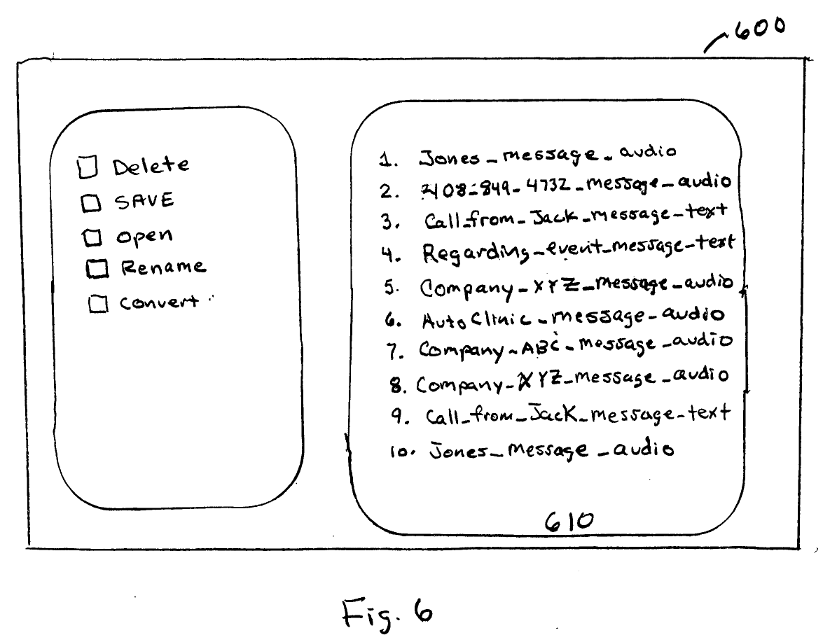

FIG. 6 illustrates a user's display screen displaying telephone messages received from a telephone messaging system in accordance with one embodiment of the invention.

Display screen 600 shown in FIG. 6 includes a message display 610 and a control panel 620 providing the user with various actions to be taken in regard to each of the messages displayed in message display 610. Exemplary actions that may be taken by a user include deleting a message, saving a message, opening a message (i.e., accessing the contents of the message), renaming the message file, or converting the message file (e.g., from an audio file to a text file). Some or all of these actions as well as others may be available to a user depending on the processing system employed. For example, if the processing system has limited memory, it may not be possible to save or convert or even open the messages. Even then, the user may benefit by being able to delete many unwanted messages. On the other hand, the user's processing system may contain all of the functionality of the message conversion system as described above.

As shown in FIG. 6, the user has ten messages numbered 1-10 in chronological order as received. The messages shown are either audio or text files, but could as well be video or multi-media files. The filenames have been determined in various ways in accordance with embodiments of the invention. The messages may also have date and time stamps associated with them as well as message duration information.

Using the information displayed, the user may be able to save time and effort in addressing received telephone messages. For example, message 1 is audio message file from Jones. Because message 10 is also from Jones and was received subsequently, the user may wish to bypass message 1 in favor of message 10 as the user may consider that message 10 has the most up-to-date information from Jones. Message 2 is from a particular phone number which the user may recognize and wish to save or delete based upon the number. Messages 3 and 4 are text message files with information regarding their content. The filenames for messages 3 and 4 were determined using context recognition and not conventional caller identification information was available. If the user does not wish to receive a message from Jack, then message 3 can be deleted. Also, as discussed above, since the user has a subsequent message from the same caller, the user may opt to access the subsequent message. If the user wishes to obtain information regarding the event signified by the filename of message 4, the user can access or save the file. Either message can be accessed in a situation in which listening to an audio message is not desirable.

Message 5 is identified (e.g., through caller identification) as being from Company XYZ. The user may not wish to hear from Company XYZ, but wish to hear from the AutoClinic (e.g., where the user's car is being repaired), message 6, or from Company ABC, message 7. In that case messages 5 and 8 can be deleted without accessing. Message 6 can be accessed immediately and then permanently saved. Message 7 can be bypassed for the present.

General Matters

Therefore, using embodiments of the invention, the user no longer has to listen through all of their messages to take action regarding particular messages. A user can permanently save messages as desired. A user can be presented with information regarding the caller even where no conventional caller identification information is available. A user can review and access messages where typical messaging services may not function. These and other advantages will be apparent to those skilled in the art.

Embodiments of the invention have been described as including various operations. Many of the processes are described in their most basic form, but operations can be added to, or deleted from, any of the processes without departing from the scope of the invention. For example, an embodiment of the invention is described, in reference to FIG. 4, in which a recorded message is converted to a message file suitable for transmission over a network at operation 415. For one embodiment of the invention, the message from the caller may be received in a suitable format and need not be converted.

Embodiments of the invention include various operations. The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central site or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a telephone call from a caller;
prompting the caller to present a message;
receiving and storing the message presented by the caller;
converting the stored message to message file suitable for communication over a network; and
communicating the message file to a network address associated with a user.

2. The method of claim 1 wherein the message presented by the caller is a voice message.

3. The method of claim 2 wherein the network address is an e-mail address of the user and the message file is an audio message file attached to an e-mail message.

4. The method of claim 3, wherein the message file has an associated filename based upon a contents of the message.

5. The method of claim 2 wherein the message file is text file.

6. The method of claim 1 wherein the message is a video message.

7. A system comprising:
means for receiving a telephone call from a caller;
means for prompting the caller to present a message;
means for receiving and storing the message presented by the caller;
means for converting the stored message to message file suitable for communication over a network; and
means for communicating the message file to a network address associated with a user.

8. The system of claim 7 wherein the message presented by the caller is a voice message.

9. The system of claim 8 wherein the network address is an e-mail address of the user and the message file is an audio message file attached to an e-mail message.

10. The system of claim 9, wherein the message file has an associated filename based upon a contents of the message.

11. The system of claim 8 wherein the message file is text file.

12. The system of claim 7 wherein the message is a video message.

13. A machine-readable medium that provides executable instructions, which when executed by a processor, cause the processor to perform a method, the method comprising:
receiving a telephone call from a caller;
prompting the caller to present a message;
receiving and storing the message presented by the caller;
converting the stored message to message file suitable for communication over a network; and
communicating the message file to a network address associated with a user.

14. The machine-readable medium of claim 13 wherein the message presented by the caller is a voice message.

15. The machine-readable medium of claim 14 wherein the network address is an e-mail address of the user and the message file is an audio message file attached to an e-mail message.

16. The machine-readable medium of claim 15, wherein the message file has an associated filename based upon a contents of the message.

17. The machine-readable medium of claim 14 wherein the message file is text file.

18. The machine-readable medium of claim 13 wherein the message is a video message.
